(19) United States
(12) Patent Application Publication
(10) Pub. No.: US 2006/0136923 A1
(43) Pub. Date: Jun. 22, 2006

(54) System for distributed task execution

(76) Inventors: Robert E. Kahn, McLean, VA (US); David K. Ely, Oakton, VA (US); Guido Van Rossum, Reston, VA (US); Theodore R. Strollo, Oakton, VA (US); Barry A. Warsaw, Silver Spring, MD (US)

Correspondence Address: FISH & RICHARDSON PC, P.O. BOX 1022, MINNEAPOLIS, MN, 55440-1022, US

(21) Appl. No.: 11/317,721

(22) Filed: Dec. 22, 2005

Related U.S. Application Data
(63) Continuation of application No. 08/720,092, filed on Sep. 27, 1996, now abandoned.
Application No. 08/720,092 is a continuation-in-part of application No. 08/453,486, filed on May 30, 1995, now abandoned.

(51) Int. Cl. G06F 9/46

(52) U.S. Cl. 718/100

(57) ABSTRACT

A method for use in a distributed system for processing a knowbot program that has the ability to move from node to node in the distributed system. In the method, an operating environment in each of the nodes provides service facilities useful to the knowbot program. And,.in the operating environment, a supervisor process is run that enables the knowbot program to make use of the service facilities but does not permit direct access by the knowbot program to facilities of the operating environment.

### BACKGROUND OF THE INVENTION

This invention relates to distributed task execution.

### GLOSSARY OF TERMS

Below, for convenience, we set forth a short glossary of terms which supplement explanations of certain terms used in the main text.

“Network” is set of computers and a communication medium which interconnects them.

“Network participant” is an entity that may require a task to be done and has access to a distributed network.

“Packet” is an elemental container for carrying data in a distributed system; it typically includes addressing information used in routing.

“Protocol” is a set of commonly agreed rules which define the structure, format, procedure and/or function that must be followed for elements of a distributed system to communicate with each other.

“Resource” is information or a service accessible at a location in a distributed system.

“Task” is something capable of being done using one or more resources.

“Digital object” generally means sequences of digits (containing digital representations of virtually any kind of information) including an associated unique identifier, called its “handle.”

“Repository” is a resource that provides typically long-term storage for digital objects and makes them accessible over the network according to applicable terms and conditions.

“Database” is an organized body of information structured so as to analyze queries and furnish replies. A digital object may itself contain a database or elements of a database.

“Rights holder” is a person or entity which has legally enforceable “rights” in a digital object.

“Distributed system” may include a Knowbot system, as well as components which are outside the Knowbot system, such as magnetic diskettes, optical disks, and other large scale storage media, including digital representations of data on paper.

“Knowbot program (KP)” is an executable computer program, which may be capable of moving from one location to another. It includes an “instruction sequence” which defines a series of steps to perform a task and also includes other data.

“Courier” is used, on occasion, to refer to an instance of a Knowbot program which is engaged in moving through a distributed system.

“Knowbot system” is a system (including programs) for creating, storing, and moving Knowbot programs among computers, executing the programs, and moving to and storing the results as needed at destination computers or the Network.

“Knowbot service station (KSS)” is software and/or hardware operating at a location on a network and capable of actions such as generating, storing, executing and deleting Knowbot programs.

“Knowbot operating system (KOS)” comprises a key software component of a Knowbot service station.

“Knowbot operating environment (KOE)” is a medium for handling Knowbot programs and comprises a collection of Knowbot service stations. The Knowbot system provides the operating environment.

“Knowbot-framework” is a conceptual model which defines a currency (Knowbot programs) for task execution and a medium (Knowbot service environment) for handling the programs.

“Meta-data” is information pertaining to a digital object which may be contained within an object or stored elsewhere.

“Key meta-data” is-information pertaining to a digital object and contained within it.

“Prospective Knowbot programs” are Knowbot programs received by a Knowbot service station from a source outside the Knowbot operating environment.

“Extension mechanism” is a mechanism that allows extensions to be added to a Knowbot service station.

“Bastion object” is an object created by a Knowbot operating system and which establishes a restricted interface to a system object.

Introduction

In the most basic sense, the invention concerns itself with a system (we call it the Knowbot system) for creating, storing and moving programs among computers, executing the programs and moving to and storing the results as needed at destination computers. While most or all of the computers may be “online” and part of a general computer networking environment, the concepts apply also to offline movement of programs via other media such as magnetic diskettes, optical disks, and other large scale storage media, including digital representations of data on paper (such as bar coding). Moreover, the computers in the system need not be simultaneously connected in an underlying network at all times; this connectivity may come and go from time to time. The label “system” generally implies some systematic regularity in the way these programs are created and managed, the way they interact with each other, the way they interact with stored information, and the way they interact with external systems, including people and programs which are considered to exist outside the scope of the definition of the programs and computers which are part of the system.

For purposes of explanation, we sometimes use the term “Knowbot system” (Knowbot is a registered trademark of the Corporation for National Research Initiatives) to refer to portions or all of the system. The Knowbot® system has well-defined boundaries which make it possible to distinguish the components that are part of the system from components which are outside of it and which interact with it only in ways defined by the system. What is inside the Knowbot system and what is outside may together be called a distributed system. The parts which are considered inside the system interact with other parts only in prescribed ways. The rules which define proper behavior are, in effect, specifications which determine how a component can be created and can operate so as to always be considered a properly functioning component of the system.

The Knowbot system is largely a software system whose components are programs which operate in prescribed ways. Software operates in a computer-based (hardware) environment and often in association with software-based operating systems which are the basic programs that create, allocate and manage resources on the hardware. Underlying the basic design of the Knowbot system is the assumption that the computers on which the system is operated have operating systems which provide functions needed by the Knowbot system running “on top of” the operating systems. Any operating system would be suitable if it supports the embedding of the underlying computers in a data communications (networking) environment and is capable of “time-sharing” multiple programs running concurrently under the overall control of the operating system. In addition, the programs (called Knowbot Programs or KPs) which are capable of moving between computers contain sufficient information to allow them to begin or resume execution as intended and the computers provide the necessary support environment such as interpreters, schedulers, and storage. The Knowbot system may be implemented atop a wide variety of hardware and operating systems.

It is also assumed that the computers that are part of the Knowbot system are at least intermittently connected to a common communication network so that information can pass from one computer to another from time to time, in accordance with the rules of behavior of the Knowbot system.

The Knowbot system links together into a common operating environment many diverse and distinct systems and resources and serves as an interconnection system between them. Information about one system or its resources may be communicated to another system via the intermediary mechanism, the Knowbot system. The Knowbot system may itself enable tasks to be carried out distinct from the systems and resources which participate. The Knowbot system may also facilitate these participating systems and resources to carry out a given task.

Below we discuss concepts which, when taken together, describe how a collection of software, hardware, and communication facilities can be organized to function as a Knowbot system. Virtually all of the concepts are based on software artifacts behaving in accordance with a set of prescribed rules. These artifacts include “running programs” and also “digital objects” that are stored away in “repositories” for later access. The concepts of the invention generally are rooted in the definition and behavior of software artifacts rather than on the specifics of any particular hardware, communication network, or operating system. However, if desired, portions or all of the software could be replaced in certain instances with a system of integrated circuits (e.g., semiconductor chips) if and when the technology of very large scale integration permits.

Knowbot programs are the basic software elements that execute in a given machine. An instance of a Knowbot program is a Courier, the form taken by a Knowbot program as it moves from one computer to another within the system or when it interfaces with the external world. Knowbot programs can contain (carry) information (data) which can be made manifest in a variety of ways. Provision is made in the Knowbot system for dealing with the arrival and departure of Knowbot programs, for the exchange of information between Knowbot programs and other Knowbot programs, and for the interaction of Knowbot programs with other parts of the Knowbot system including information access subsystems called “repositories” and with external subsystems, including people, by means of visible, audible, or other palpable manifestations.

An important characteristic of Knowbot programs is their ability to protect data on behalf of rights holders, to control its application in accordance with stated terms and conditions and to interpret data, rendering it in multiple ways to be visible, audible or otherwise palpable and in such a way as to permit human interactions to influence the choice of renderings.

Because the Knowbot system has a software based open-architecture interconnection structure, it is useful to discuss another highly successful software-based open-architecture interconnection system known as the Internet. The Internet-is a rapidly growing, global “network of networks” which links millions of computers and tens of thousands of networks together. The Internet is realized through a set of minimum requirements for linking computers to each other by way of a “packet switching” environment and through observing certain format and procedural conventions (“protocols”) that govern how and when and in what form information is exchanged among the computers which are part of the Internet.

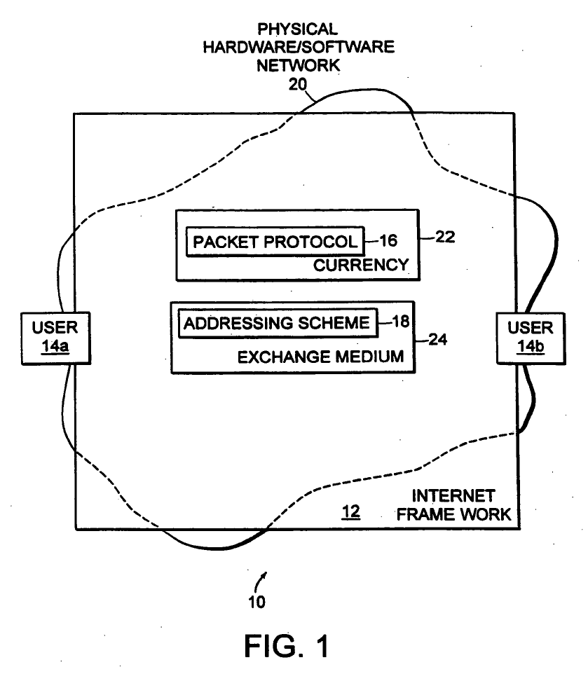

As seen in FIG. 1, the Internet 10 provides a communication framework 12 for computer users located essentially anywhere in the world. Any computer 14a may send digital information to any other user 14b by observing a commonly understood packet protocol 16 and a commonly accepted addressing scheme 18. The packet protocol sets minimum rules for the structure and handling of packets which carry the digital information, including the address of the recipient. The addressing scheme sets minimal rules for addressing assignments including prevention of duplicate addresses. A computer that follows the packet protocol and the addressing scheme may be relatively confident that a packet will reach its destination and that the recipient will be able to access the digital information carried in it. On the other hand, the Internet framework makes essentially no attempt to define the physical hardware/software network components 20 that are used to format, transmit, receive, disassemble or assemble packets, and instead leaves those matters to users, groups of users, and vendors. This has resulted in an open, distributed market for implementation schemes and products.

Because the hardware/software requirements of the packet protocol are minimal, and essentially any digital information may be carried in them, they provide a “currency” 22 for exchange of digital information across a distributed network, just as paper checks provide a legal tender for exchange of economic value. The unambiguous addressing scheme and other aspects of the Internet framework in turn provide a universal medium 24 for exchange of packets, just as the unambiguous transit codes of the Federal Reserve clearinghouse provide a universal medium for exchange of checks. But the Internet framework places no limits on the physical manner in which users may create, transmit, receive, and use packets, just as the clearinghouse system places no restrictions (provided paper size and other check protocol requirements are met) on how checks are created, delivered, received, or used.

The notion of disconnecting the medium and currency for exchange of digital information on a widely distributed network (i.e., the framework) from the physical implementation (suggested-by the somewhat disjointed representations 12 and 20 on FIG. 1) is a powerful one and has led to the great success of the Internet, for it permits individuals and non-commercial and commercial enterprises to participate and benefit from the Internet without requiring central control of the implementation. At the same time the Internet community is constantly working to enhance and improve the principles embodied in the commonly accepted Internet framework. This is achieved through a decentralized process in which concepts may be generated from any source, tested, and if found broadly useful, ultimately become part of the accepted framework. In this context it is largely the quality of the proposed principles that generally governs whether they become part of the framework and are widely adopted.

Another powerful feature of the Internet framework and the physical network on which it is implemented is its ability to coexist easily with other frameworks of communication and other physical networks. The Internet currently accommodates many different types of networks and communications media; in principle almost any network or communications media can become part of the Internet.

Finally, the Internet framework is highly scalable which has yielded a relatively easy expansion of the number of users worldwide.

### SUMMARY OF THE INVENTION

In general, in one aspect, the invention features a method for use in a distributed system for processing a knowbot program that has the ability to move from node to node in the distributed system. In the method, an operating environment in each of the nodes provides service facilities useful to the knowbot program. And, in the operating environment, a supervisor process is run that enables the knowbot program to make use of the service facilities but does not permit direct access by the knowbot program to facilities of the operating environment.

Implementations of the invention may include one or more of the following features. A bastion object is created in the unrestricted environment to protect the unrestricted environment and the bastion object is passed into a restricted environment within which the knowbot program is running. The bastion object provides an interface for the knowbot program to access the service facilities in a safe manner and which is substantially the same interface as the interface that the service facilities provide in the unrestricted environment. The bastion object performs type checking on all method calls made by a knowbot program to a service facility.

In general, in another aspect, the invention features a method for use in a distributed system for processing a knowbot program that executes in one node of the distributed system, may be interrupted at almost any point in its execution, and may be moved to another node of the distributed system for further execution. In the one node, a current state of the knowbot program execution is captured. The captured state and program code of the knowbot program is provided to the other node. Execution is continued at the other node from the point of interruption based on the captured state and the program code.

Implementations of the invention may include one or more of the following features. Also delivered with the captured state and the program code is a transported file system of information or other information created during execution of the knowbot program. The information in the transported file system or other information is accessible without executing the knowbot program. The step of capturing comprises using an encoding scheme of a language interpreter.

In general, in another aspect the invention features a method for enabling communication with a knowbot program running in a distributed system, a knowbot service station, an extension, or another application. A connector mechanism is provided which permits each of the knowbot programs, knowbot service stations, extensions, and other applications to identify services that it provides, and permits each of them to find services that it needs. Knowbot programs are enabled to communicate with knowbot service stations via connector objects associated with the connector mechanism.

Implementations of the invention may include one or more of the following features. The connector object is provided by a supervisor process running in the distributed environment and the connector object prevents uncontrolled access to a needed service. The connector mechanism includes a connector broker and connector manager. The connector objects are data typed.

In general, in another aspect, the invention features a method for enabling negotiation between two unrelated knowbot programs, knowbot service stations, extensions, or other applications, in a distributed system. In an operating environment in a node of the distributed system, information is received from one of the two knowbot programs, knowbot service stations, extensions, or other applications, concerning a transaction offered to other knowbot programs, knowbot service stations, extensions, or other applications. In the operating environment in the node, information is received from the other of the two knowbot programs, knowbot service stations, extensions, or other applications concerning a transaction in which the other of the knowbot programs knowbot service stations, extensions, and other applications wishes to engage. The other knowbot program, knowbot service station, extension, or other application is notified of the one knowbot program, knowbot service station, extension, or other application. The two knowbot programs, knowbot services stations, extensions, or other applications are then enabled to communicate concerning the transaction. In implementations of the invention, the information is received from the two knowbot programs by a third knowbot program.

In general, in another aspect, the invention features a method for enabling action by an operating environment in a distributed system with respect a knowbot program which is programmed in a language that is not fully supported by the operating environment. A knowbot program is labeled to identify operating environment features required for full support of the knowbot program. In an operating environment, the labeling of the knowbot program is examined to determine whether the operating environment supports all of the identified features. An action is taken based on whether all the identified features are supported.

Implementations of the invention may include one or more of the following features. The action comprises sending the knowbot program to another operating environment for processing. Or the action comprises retrieving non-program specific data from the knowbot program.

In general, in another aspect, the invention features a method for aiding communication with a knowbot program executing in operating environments provided at nodes of the distributed system. A name space is maintained that uniquely identifies types of information to be interchanged. A name is used within the name space to identify the type of information to be interchanged.

Implementations of the invention may include one or more of the following features. The knowbot program registers an interface which includes the name of a type of information that is to be interchanged.

In general, in another aspect, the invention features a method for controlling the timing of execution of an action associated with a knowbot program running in an operating environment provided at a node of a distributed system. A trigger protocol is provided in the operating environment. The knowbot program is enabled to register a condition with the operating environment. The operating environment is caused to trigger the execution of the action upon the occurrence of the condition.

Implementations of the invention may include one or more of the following features. The trigger protocol defines trigger statements each of which identifies at least the condition and the action. The operating environment maintains a table of registered trigger expressions for all knowbot programs that have registered conditions. The execution is triggered by a program contained in the knowbot program.

In general, in another aspect, the invention features a method for controlling interaction between a knowbot program and an application running in an operating environment provided at a node of a distributed system. A trusted portion of the operating environment is defined which provides trusted services to the knowbot program. Portions of the application which are running in the operating environment are required to be registered as trusted. Indirect interaction via the operating environment between the knowbot program and the application running in the operating environment is permitted only if the portions of the application required to be registered have been registered.

In general, in another aspect, the invention features a method for enabling a knowbot program to carry out defined functions including otherwise unsafe functions, through the use of extensions. Safe extensions are coded to an operating environment and to the interpretive language under which the knowbot program runs. The knowbot program is permitted to carry out the defined functions by making use of the extensions. This will simply be a close paraphrase of the claims.

Other advantages and features of the invention will become apparent from the following description and from the claims.

### DESCRIPTION OF THE PREFERRED EMBODIMENTS

FIG. 1 is a block diagram of an Internet framework.

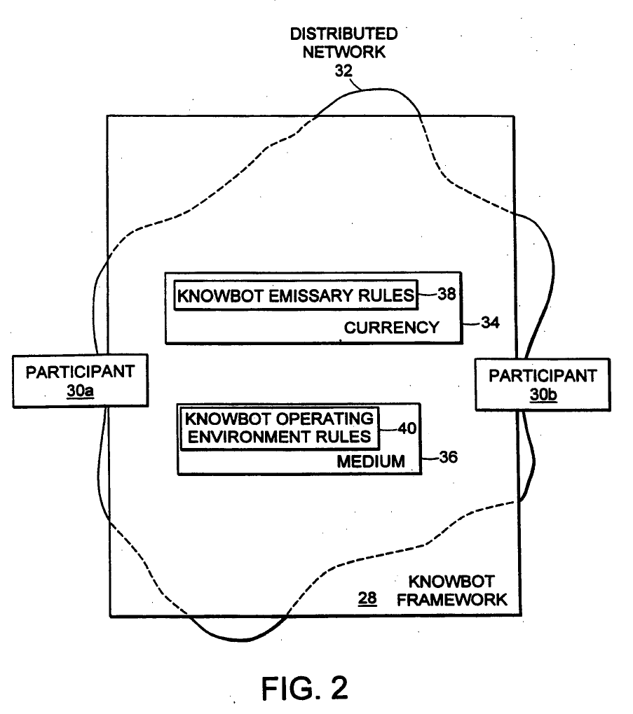

FIG. 2 is a block diagram of a Knowbot framework.

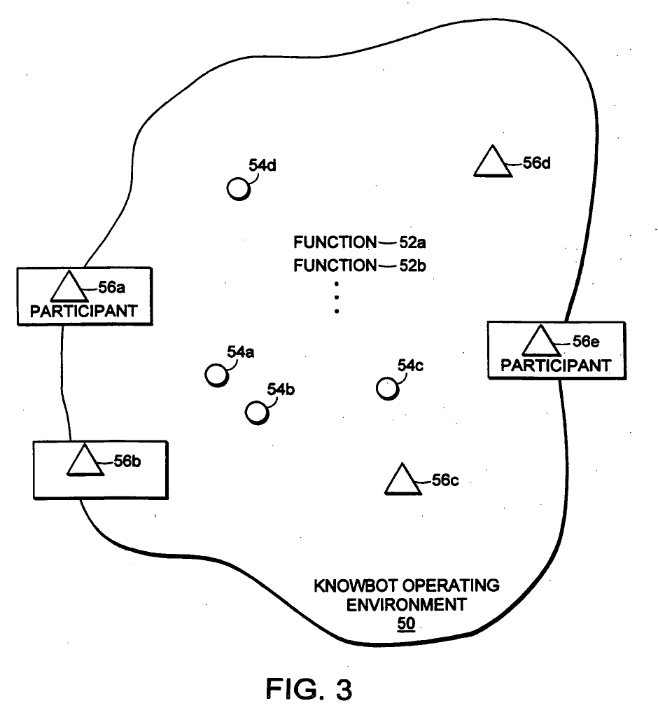

FIG. 3 is a block diagram of a Knowbot operating environment.

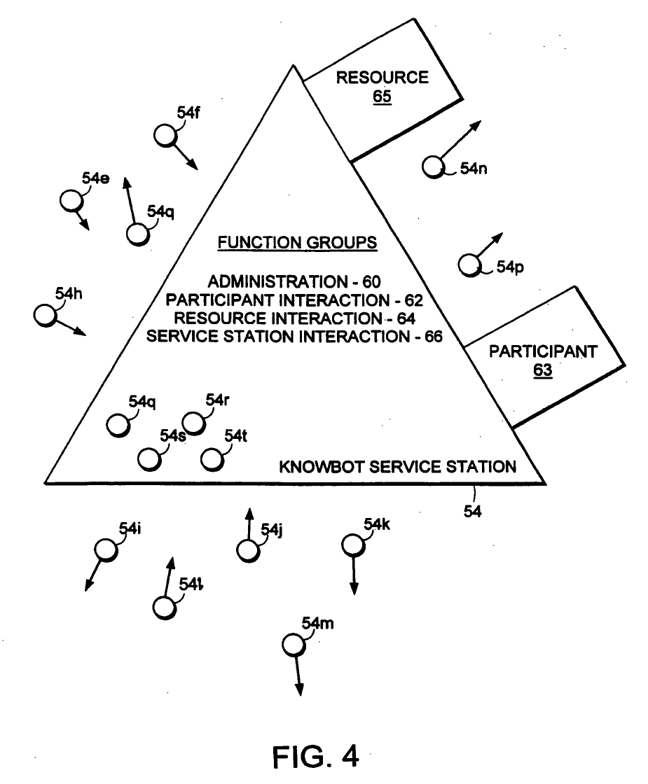

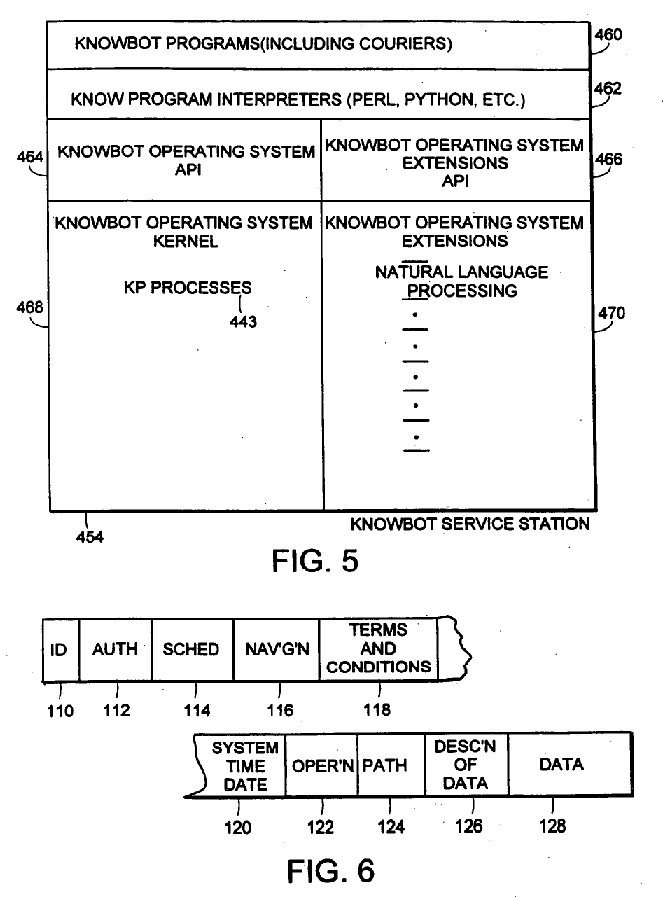

FIGS. 4 and 5 are block diagrams of Knowbot service stations.

FIG. 6 is a diagram of the contents of a Knowbot program.

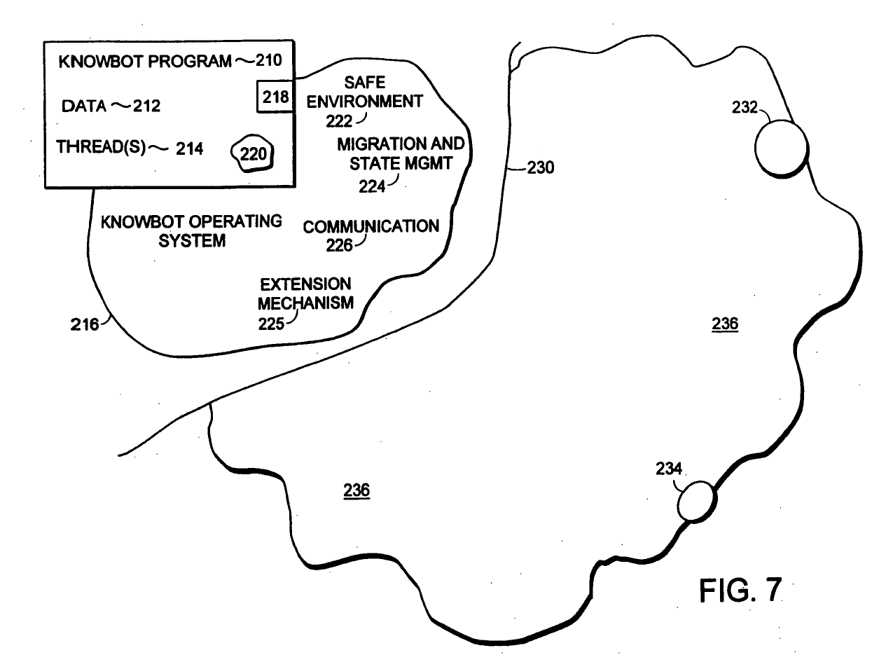

FIG. 7 is a block diagram of a Knowbot program and a Knowbot operating system.

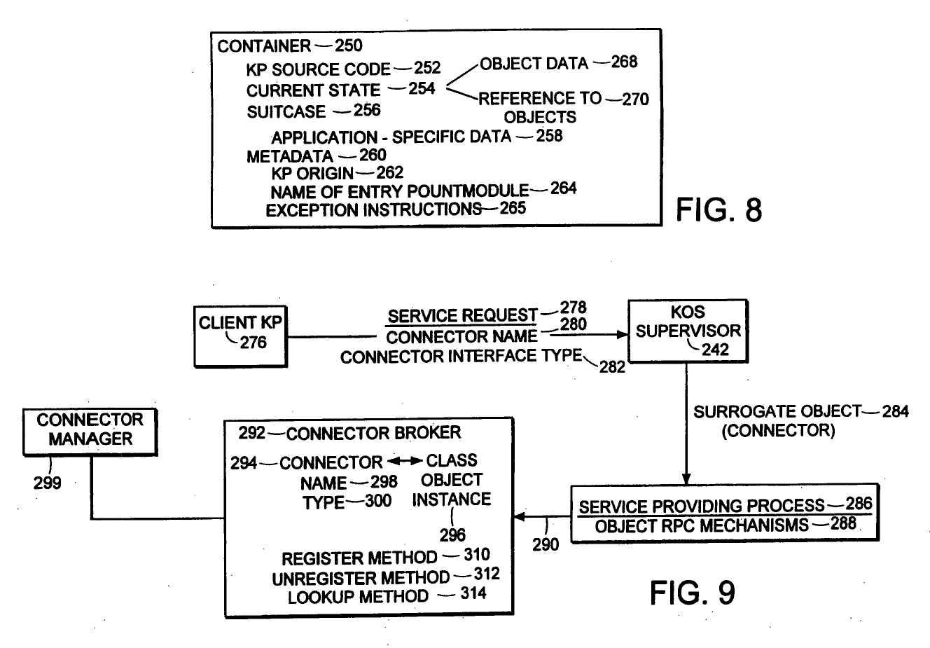

FIG. 8 is a diagram of a package for transporting a Knowbot program.

FIG. 9 is a block diagram of a connector facility.

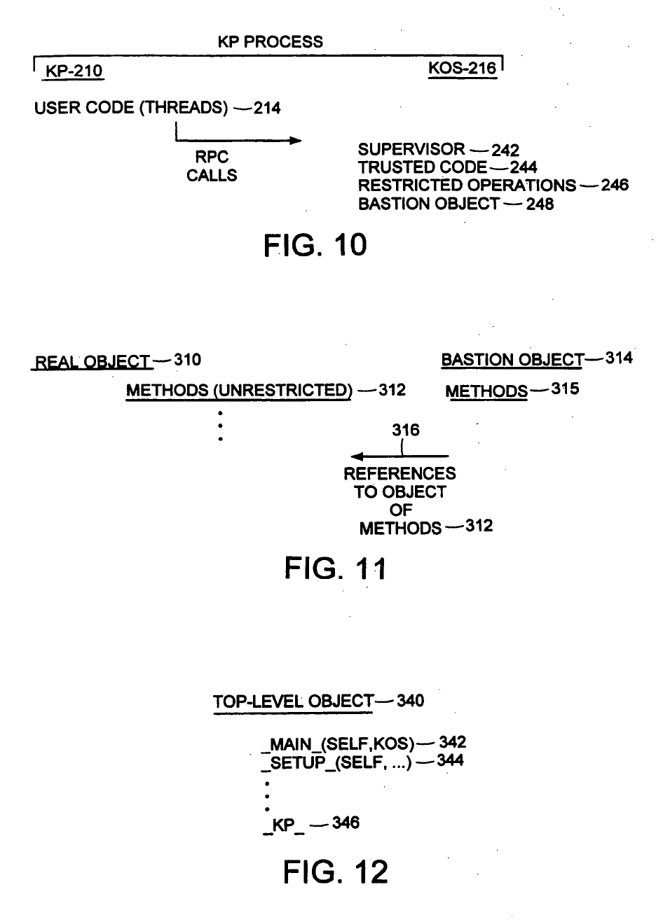

FIG. 10 is a block diagram of a KP process.

FIG. 11 illustrates a bastion object.

FIG. 12 illustrates the top level structure of a Knowbot program.

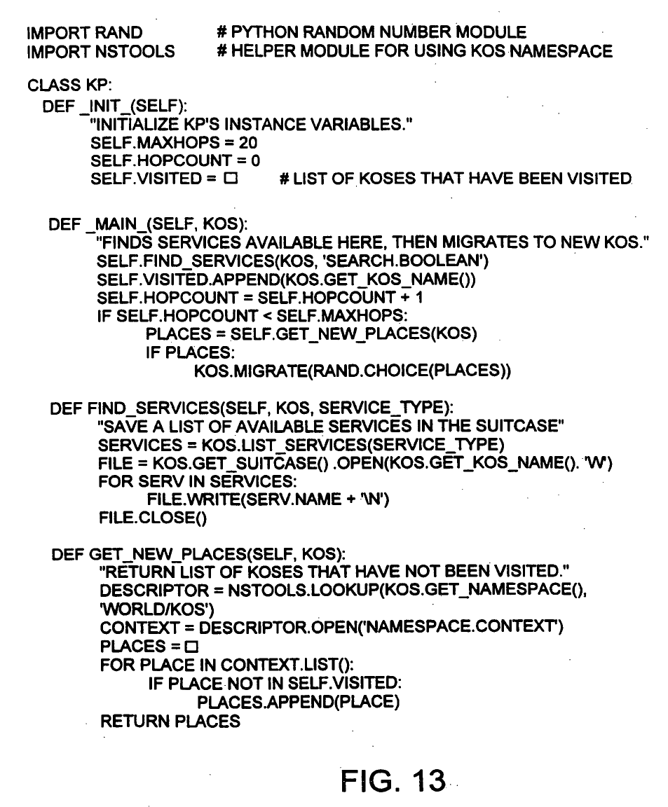

FIG. 13 is an example of a Knowbot program.

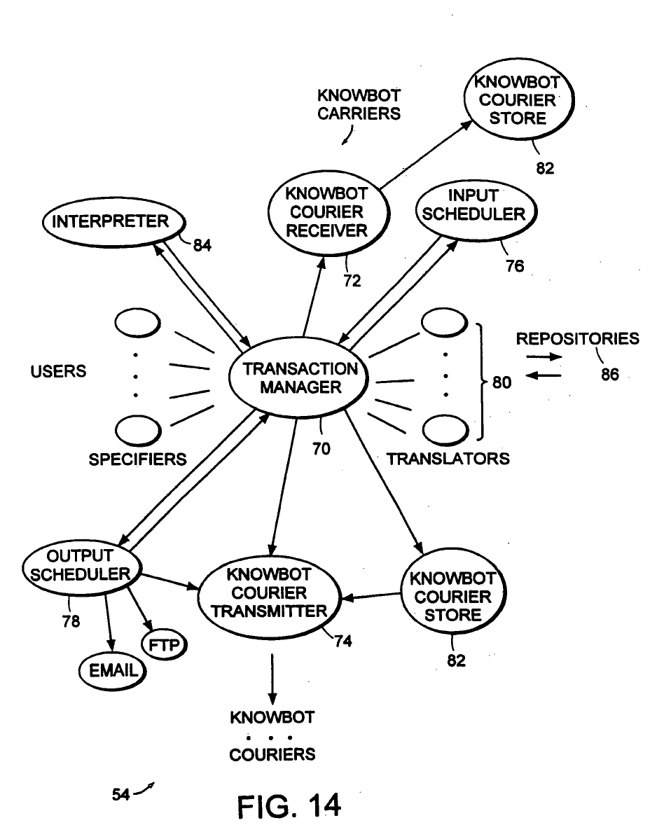

FIG. 14 is a block diagram of a transaction manager.

As seen in FIG. 2, in the invention, a new and more powerful framework (called a Knowbot framework 28) is created not merely for communicating digital information (as in the case of the Internet framework), but for having tasks done on behalf of network participants 30a, 30b using resources available on a distributed system 32 (e.g., the Internet, or another network). Within the phrase “network participants” we include any entity that may require a task to be done, including individuals with standalone personal computers and organizations, as well as computers and other hardware and software in the network. By “task” we mean anything that is capable of being done by resources on the network; tasks may have a wide range of complexity, and typically they involve more than merely a communication of digital information of the kind effected by delivery of a simple Internet packet containing the digital information; in particular, tasks often involve a process step to be taken at a location that is remote from the location of the entity that requires the task to be done. By “resources” we mean whatever is available on the network that can contribute to the doing of a task; this could include computer software, stored digital objects and a wide variety of services.

The Knowbot framework defines both a “currency” for having tasks of any arbitrary complexity done, and a “medium” for handling the currency as part of getting the tasks done. The currency is called Knowbot programs. A Knowbot program is a mobile emissary of a network participant which assists in executing a task to be done on behalf of the participant. This task may be carried out locally in the user's system or it may involve interactions with other systems and resources at other locations both local and/or remote. The medium for handling Knowbot programs is called-a distributed Knowbot operating environment or simply the Knowbot operating environment. The Knowbot operating environment is distributed as a potentially endless number and variety of what we call Knowbot service stations (software and/or hardware) operating at places on the network. The stations may generate, store, execute and delete Knowbot programs and otherwise perform all allowed operations on Knowbot programs as determined by the Knowbot program itself or by users authorized to take or enable such actions. The Knowbot framework defines a minimal set of rules 38 for the structure of Knowbot programs (for example, the program must include some information related to the task to be done) and a minimal set of rules 40 for the functions to be performed within the Knowbot operating environment (for example, that a typical Knowbot service station be able to create, send, receive, monitor, and delete Knowbot programs).

Although we describe below some additional specific principles for Knowbot programs and the service environment, in general it is contemplated that enhancements to the Knowbot framework will be developed in a similar manner as for the Internet framework, that is, by a combination of free market forces with respect to hardware and software implementations, and by an open standards development process within the Knowbot user community with respect to framework principles. Like the Internet framework, the Knowbot framework is meant to coexist freely with other techniques for doing tasks within a network and to be easily expandable.

FIG. 3 depicts the Knowbot operating environment 50 which provides an extremely wide variety of functions 52a, 52b, . . . for handling Knowbot programs 54a, 54b, . . . via an essentially unlimited number and variety of Knowbot service stations 56a, 56b, . . . each in the form of hardware and software running at a location on a distributed network. Examples of Knowbot service stations would include software running on an individual user's PC or laptop (service station 56a) or on a repository or database server of a participant that is a supplier of digital objects (service station 56e), or on a smart card or other personal digital equipment or artifact, or on a telephone company central office switch (service station 56b).

Some of the most basic functions to be provided by the Knowbot operating environment include aggregation and presentation services which involve how information is collected and organized and presented to end user participants and how requests for tasks to be performed are elicited from end user participants; searching and consolidation services which involve how queries are presented to repository participants and other resources and how results are consolidated for presentation to these resources; and assurance/protection services which validate the authenticity of Knowbot programs and Knowbot service stations and their performance, and that rights in digital objects will be effectively protected by these programs and service stations in accordance-with stated terms and conditions. These services are discussed in more detail below.

As seen in FIG. 3, the KSSs are the substrate which makes it possible for Knowbot Programs (KPs) to perform their tasks. The interconnections between the KSSs make it possible for the KPs to migrate between KSSs. A KSS is also informally referred to as a host.

Knowbot Service Stations

The Knowbot service station is analogous to an operating system but does not allow participants to create arbitrary programs and files or to run arbitrary programs, although it could allow selected users with special system status great flexibility to manage the service station and to upgrade its performance. In general, the service station creates Knowbot programs in response to participant specifications and/or its own internal requirements. Prospective Knowbot programs may also arrive from external sources such as a user's PC that is not also a service station and can be authenticated by a service station for use in the Knowbot environment. Prospective Knowbot programs may also arrive on external media such as CD-ROM. The service station also processes Knowbot programs received from other service stations, and stores and manages Knowbot programs within its own environment.

As seen in FIG. 4, the functions performed at each service station may generally fall into four major categories: i. basic administration 60 of Knowbot programs, include creating, sending, receiving, authenticating, executing, storing, monitoring and deleting them; ii. interaction 62 with a participant 63 to aid the participant in defining tasks to be done and to provide the results of doing tasks in forms and at times that are useful; iii. interaction 64 with a participant which is serving as a resource 65 in getting a task done, including conveying requests for information or actions in formats and at times that will be understood by the resource and processing the information or results of the actions; and iv. interacting with other service stations 66 and interacting with hardware and software that is not part of the Knowbot framework to enable a limited set of external, possibly untrusted actions when appropriate and allowable.

Knowbot programs 54e through 54p may pass from Knowbot service station to Knowbot service station in the Knowbot operating environment by a variety of mechanisms, for example by being transported in Internet packets. Knowbot programs 54q through 54t also may stay for periods of time in a given Knowbot service station and in that sense the host Knowbot service station may be thought of as a hotel and/or processing plant for Knowbot programs.

Referring to FIG. 5, the general structure of a generic Knowbot service station includes storage 60 for Knowbot programs and Knowbot program interpreters 62 for interpreting Knowbot programs written in languages such as (but not limited to) PERL or PYTHON. A core Knowbot operating system 68 provides basic key functions (discussed below) and provides a Knowbot operating system application program interface (API) 64 which provides a predefined interface to and thus enables application programs to be easily written to interact with the operating system. A Knowbot operating system extensions mechanism (API) 66 provides an interface to extensions 70. The extensions can include an almost limitless variety of services and functions that supplement the basic functions of the operating system, such as natural language processing.

Simple Knowbot service stations need only be able to, perform-a small set of basic functions and they may be implemented easily and in a straightforward way in the form of a software program or VLSI chip. Other more complex Knowbot service stations will have a variety of special functions suitable to their locations in the network and to the entities with which they are expected to interact.

We turn to a discussion of a simple Knowbot service station with minimum basic functionality. As shown in FIG. 14, the heart of the Knowbot service station is the transaction manager 70 which acts as a kind of traffic cop and status handler to supervise activities within the service station. The transaction manager interacts with a Knowbot program receiver 72 where Knowbot programs arrive at the service station, and with a Knowbot program transmitter 74 where outgoing Knowbot programs depart the service station. An input scheduler 76 keeps track of the arrival of Knowbot programs and assures that they are scheduled for handling in the service station at the appropriate time. An output scheduler 78 similarly keeps track of Knowbot programs that are to be sent out of the service station and assures that they are transmitted in due course.

Knowbot programs that arrive from an external source go directly to the receiver. The receiver provides access control and evaluates whether the incoming Knowbot program may properly enter the service station. If so, it stores the program in a store 82. If not it may discard the program or take some corrective action with respect to it. Knowbot programs that are generated locally, e.g., from a resource at the same location as the service station, are generated by or handled by a translator or by a specifier and are passed to the transaction manager for further disposition. The transaction manager may place the locally generated program in a store for subsequent processing or transmission, or it may hand it directly to the transmitter for immediate dispatch.

The input and output schedulers determine what action to take with respect to each entry in the Knowbot program store. Actions could include performing steps called for by the program either immediately or at some later time or periodically or after some other event has occurred. When the time has come to perform such a processing step, the input scheduler notifies the transaction manager. When the time comes to transmit a program, the output scheduler notifies the transmitter.

The transaction manager manages all transactions in the service station and carries out periodic checks of status. It keeps track of ongoing transactions and notifies other service stations of status and error conditions (one way to provide the notice is by sending new Knowbot programs to the other service stations). The transaction manager maintains information about Knowbot programs created by the service station, and deletes Knowbot programs when appropriate. If it deletes a Knowbot program that originated in another service station it will generally notify the other service station of such action.

The transaction manager invokes the aid of an interpreter 84 to execute a Knowbot program. This may occur, for example, to determine whether a received Knowbot program is intended for a local user or for a local repository or for another site. The interpreter “interprets” the program (e.g., runs the Knowbot program) to determine what actions to take. If intended for a local user, the results of the interpretation are passed to a specifier which then communicates with the user. For example the specifier could deal with presentation matters such as what images can appear on a screen, or how many actions of a given type may be taken on behalf of the user. This information may be derived from the Knowbot program

If intended for a local repository 86 (e.g., if the task represented by the program is to access some information in the repository), then the interpreted Knowbot program determines which repository to access and plans the execution method (e.g., serial or parallel, level of granularity, and how to order or combine the information). It then passes the results of the interpretation along with the program to one or more translators which then communicate with the repository. The translators convert the requests that are represented by the program to the language of the local repository. The local repository may be able to execute the request directly. If appropriate for another site then the transaction manager passes it to the transmitter for dispatch over the network to the intended site, which will generally be another service station but which may be a repository, a gateway, or some resource outside of the Knowbot operating environment.

The repository search results would then be passed back through the translator which would format it, place it in the store 82, and notify the transaction manager. The transaction manager would then mark the transaction finished and make an entry in the output scheduler module.

The output scheduler provides a variety of return policies. Normally, the results would be returned in the form of a program in which case the transmitter 74 sends the program when and how indicated by the output scheduler. In addition, the results could be communicated in another medium (e.g., e-mail or file transfer) or made available in a suitable “markup language” for delivery. The markup language provides a self-describing form of information that denotes its substructure so that another interpretation is possible downstream. The results may be returned to the user or returned to a designated intermediate location for storage or processing.

Integrity of Knowbot Programs is only guaranteed as long as the integrity of the KSS is guaranteed. Maintaining the integrity of the KSS is similar to maintaining the integrity of any high-security hardware, such as the computers used by banks or the military for critical parts of their operations.

The KOS actually consists of a number of cooperating processes running different components of the KOS. The system hardware and low-level system software must be of sufficient power to support this KOS architecture, for example, Unix workstations and the Unix operating system

There is one designated process called the KOS kernel 468 (FIG. 5) (not just “kernel”, to prevent confusion with the Unix kernel). Other processes 43 are assigned to running KPs (one process per KP). The KOS kernel keeps track of all its associated KP processes. When it decides to create a new KP process, it forks off a KP bootstrap program, passing it a description (e.g., a filename) of the KP, which initializes and becomes a new KP process. The KP bootstrap program becomes the KP supervisor (see below) once the KP user code is running. In the case of a KP written in Python, the KP bootstrap program is a Python script.

The KOS extensions 70 are generally permanently resident at a particular KENS (though they may conceivably be loaded dynamically or at least started and stopped at the discretion of the system administrator). KOS extensions are not KPs, generally have the same system privileges as the KOS kernel, unlike KPs. KPs interact with extensions in roughly the same way a they interact with each other. However, KPs may generally assume that well-known KOS extensions can be trusted more than arbitrary KPs.

Logical Structure and Operation of Knowbot Programs

The logical structure of a Knowbot program is shown in FIG. 6 in the form of fields of information that may be included to help guide the program through the network and to provide instructions for its operation. The exact order of the fields is not significant and fields may be added or changed by the service stations as the Knowbot moves through the Knowbot operating environment. In storage, various means of implementation are possible and many of the fields may be unnecessary and may be omitted.

The first field is a globally unique identifier 110 which distinguishes this Knowbot program from every other Knowbot program currently in existence in the Knowbot operating environment. It may also be useful in distinguishing Knowbot programs over long periods of time. A portion of the identifier may be derived from the identity of the Knowbot service station that created the Knowbot program. The identifier may be used for retrieving a Knowbot program from storage or to refer to a Knowbot program. If the unique identifier has semantics, the Knowbot service station that created it will provide a type and version indicator to make clear what the semantics are, or this information may be contained in the system, time and date field mentioned below.

The globally unique identifier (also called a handle) allows the existence, location, and activities of the Knowbot program to be controlled and determined with certainty while it exists in the Knowbot operating environment.

Additional information about handles is set forth in U.S. patent applications Ser. No. 08/142,161, filed Oct. 22, 1993, and Ser. No. 08/645,491, filed May 13, 1996 (the “Handles” patent applications); and in Kahn & Wilensky, “A Framework for Distributed Digital Object Services, May 13, 1995, available at http://www.cnri.reston.va.us on the World Wide Web, all incorporated by reference in their entireties.

The next (optional) field is authentication information 112 used to assure the authenticity of the Knowbot program, in particular that it was actually created by the environment that claims to have originated it. Portions or all of the Knowbot program may also be encrypted if desired.

The next field contains scheduling information 114 relating to when and how often the task represented by the Knowbot program is to be done. This may depend on cost and time constraints set forth in the field. This field may also identify required status information (including error information notifications). The scheduling information will generally assume content specific information is located elsewhere in the program. The scheduling information could indicate, for example, when the Knowbot program executes functions, how long it should exist, and when and how it should return status information. Specific examples of instructions for starting a task include (a) “run this Knowbot program tomorrow at 2 pm on repository X”; it might return a report on active Knowbot programs in the repository; (b) “run this Knowbot program everyday at noon on repository Y”; the results might be to say what has come in that is new that day; © “wait until event Z (e.g., we know which currency we want to use) and then run the Knowbot program using the results of that event,” and (d) “run this Knowbot program and if event W occurs (e.g., the value of this stock ever goes below 15), take action Q (e.g., sell it), and if it goes above 20, buy it.” The Knowbot program may also include other wake-up criteria and trigger conditions.

The next field, navigational information 116, may capture either information to control the future navigation of the program in the Knowbot operating environment and/or information about the history of the navigational path taken by the program.

The next field, terms and conditions 118, relates to areas such as authorization of payment for tasks performed on behalf of the program or terms and conditions for use. This information is protected by use of public key encryption or some equivalent mechanism for authenticating payments and other terms and conditions. The payment information can indicate allowable credit limits, ensure authentication of payment, and may be completely contained in the Knowbot program or may be associated with digital cash payment systems or other electronic payment mechanisms.

The next field, system, time, and date of creation 120, provides a tracing mechanism in case the program is copied or a record of its history is needed. A program embedded in another program will have its own system, time, and date of creation. This field may also identify a Knowbot program that can acquire the information.

The next field, operation 122, typically would contain an instruction sequence to be executed in conjunction with the contents of the Knowbot program. Any language interpretable at the Knowbot service station is permissible. The instruction sequence could even be a digital representation of natural language (e.g., English) used in conjunction with a natural language understanding program to interpret it. Simple forms of the instruction sequence might be formatted search commands, or access commands such as “access object with identifier X,” or “search for objects written by a specific named person.” It may also identify a process to be carried out, such as “execute me and pass the results to the destination(s) named in the results of the execution.”

The next field, path 124, will generally identify the most recent service station to have handled the program, and it may also contain information about the series of service stations that previously handled the program along with the times when it was handled. In contrast to the navigation field which may contain incomplete information about future as well as previous trajectories, the path field is intended to yield the definitive record of the path actually taken.

The next field, description of data 126, will generally contain a unique identifier for data, the rights associated with use of each part of data (see below), reporting requirements (if any), and directions for using the instruction sequence. The directions may be in the form of an executable program.

The final field, data 128, contains one or more of the following:

a. a digital object, by which we broadly mean sequences of digits (e.g., binary digits or bits) and an associated unique identifier which we call a “handle”. Additional information concerning digital objects and repositories may be found in the Handles patent application and the Kahn & Wilensky article. A digital object may incorporate information or material in which rights (e.g., copyright rights) or other rights or interests are or may be claimed. There may also be rights associated with the digital object itself. Thus digital objects may include digital representations of conventional works (e.g., literary or pictorial), and more broadly any digital material which is capable of producing desired manifestations for a computer user. Thus, a digital object could include programs and other data which may be based on or incorporate one or more preexisting works. The digital object may be delivered over a network and subsequently rendered on a computer screen (or other output device or devices, e.g., a printer) in whole or in part. Digital objects may include digital representations of audio, video or even 3-D scenes and artifacts, as well as bit sequences that have the potential to be rendered in many different ways and which renderings may be occurring for the first time. By the notion of rights which are or may be claimed in a digital object, we mean rights which exist under statute (e.g., copyright, patent, trade secret, trademark), or as a result of private action (e.g., via secrecy, cooperative ventures, or negotiation).

b. a sequence of bits (possibly with a data type)

c. indirect references to other entities (such as digital objects)

d. a set of the above

e. a combination of the above (including sets)

The contents description field allows the digital objects to be separately identified and processed with full cognizance of the rights and permissions associated with the contents. A digital object may itself be a Knowbot program.

Knowbot programs may communicate with each other as required to carry out tasks. Among the means for such communication are the following. 1. Multicast communication may be used to reach multiple other Knowbot programs or when the location of a target Knowbot program is not precisely known. 2. The source Knowbot program could send a message to a target Knowbot program by routing it via the Knowbot service station that created the target. 3. A mechanism could be used for direct communication from one Knowbot program to another.

In addition to a protocol or set of protocols defining how a Knowbot program is to be sent and received, the system may include a protocol or protocols defining how a message is to be sent and received. In some cases it may be more effective to send messages rather than to send the Knowbot programs themselves. E.g., a Knowbot program may arrive at a Knowbot service station and wait for a message from another Knowbot program before proceeding.

Knowbot programs may interact with each other in a Knowbot service station. Knowbot programs may be cloned in a Knowbot service station. Each Knowbot program clone may operate independently of its parent and siblings. Knowbot programs and their clones may coordinate their activities and cooperate in performing a task. More generally any Knowbot program may coordinate its work with any other Knowbot program, whether or not they are clones.

Knowbot programs may be persistent, that is they may be created with the expectation that they will maintain a vigilant presence in the Knowbot operating environment. Usually the persistent Knowbot program will reside at a particular Knowbot service station, but there may also be persistent Knowbot programs that are perpetually moving through the Knowbot operating environment.

A Knowbot program carrying a simple user query or system query may produce a complex retrieval process or other distributed task execution. Several repositories or databases may have to be interrogated to obtain all the necessary components to satisfy the retrieval or other task execution. (A repository may contain multiple databases or knowledge bases). These components may be delivered to the user as a single response or as multiple responses. In certain cases, the user may require and the system may allow all or some of the components to be delivered separately.

A Knowbot program may carry out a complex task (possibly in conjunction with other Knowbot programs, repositories, databases and/or knowledge bases) that does not correspond to a query or a retrieval. For example, it may make something happen in the network, or in a computer, or a set of computers or the network such as activating programs, setting parameters, or inserting software patches. Additional information concerning authentication and security and record keeping, and examples of Knowbot programs are set forth in U.S. patent application Ser. No. 08/453,486, filed May 30, 1995, incorporated by reference (the “Knowbots” application).

As seen in FIG. 7, a Knowbot Program (KP) 210 may be viewed as a combination of data 212 and thread(s) 214 of control that can move among nodes 230, 232, 234 in a distributed system such as the Internet 36. A Knowbot Program has well-defined entry point(s) 218 and state 220. The underlying services of the KOS 216 fall into four major categories: (1) a safe runtime environment 222, (2) migration and state management 224, (3) an extension mechanism, and (4) communication among KPs, KSSs, extensions, and trusted applications 226.

Knowbot Programs enable an agent-based programming style that is well-suited for autonomous and network-efficient applications. Agents are autonomous, able to continue operation even when disconnected from their source, and can migrate closer to data or to other programs they interact with in order to conserve network bandwidth.

The implementation discussed here uses Python, an object oriented scripting language and ILU, a multilanguage object interface system developed at Xerox PARC. The KOS architecture, however, is language- and transport-neutral.

Examples of other languages that could be adapted for use a Knowbot Programming languages are: TCL, the Tool Command Language; and the Java language from Sun Microsystems. The interfaces between these language (or bytecode) interpreters and the KOS would be formulated as ILU objects or objects in another transport framework.

Safe Environment

If a host runs programs that it receives from a network, it must somehow ensure that those programs don't execute unauthorized operations. One way of ensuring this is only to accept programs from authorized users. The usual cryptographic techniques can be used to authenticate the origin of each program. If an authorized user performs an unauthorized operation, the user's identity can therefore be determined.

There are situations where user authentication is undesirable, for instance when running a free public information service or when anonymity is required. In such situations one should restrict the power of the executing program so that it can't do any harm. This should be done without unnecessarily hampering the expressive power: the trivial restricted environment which executes no programs is theoretically the only “safe” solution, but of little practical value.

There are several types of attacks that an evil program (often called a Trojan Horse) could attempt: denial-of-service attacks, where the program allocates (nearly) all of a shared resource such as CPU cycles, memory or disk space, or networking interrupts, thereby hampering services rendered by the host to other users; attacks that delete, modify or illegally forward information stored on the host's file system; and attacks that crash the host. While the effect is the same as for the other denial-of-service attacks, host crashing attacks are more difficult to prevent since they usually exploit bugs in the host's software. Most denial-of-service attacks can be prevented by implementing limits on the amount of each resource that a program can use. This area is pretty well understood, and good protection can be had, e.g., by using the UNIX facilities for setting disk quota and resource limits.

At a higher abstraction level it is possible to modify the Python interpreter to limit the number of virtual machine instructions executed or the total number of objects allocated on behalf of a program. In a UNIX environment it is possible to prevent unauthorized access to information stored on the file system by running a process as an unprivileged user.

The Knowbot Operating Environment may need finer control over the information resources to which a Knowbot program has access. The Python interpreter allows the creation of arbitrary restricted execution environments. In such a scheme, a restricted Python execution environment is always supported by a less restricted, “controlling” environment, which controls the implementation of crucial operations in the restricted environment. In particular, the controlling environment defines the set of built-in functions available to the restricted environment (by providing a table of functions) and controls how the restricted environment can import modules. Since all access to sensitive information in Python uses either built-in functions or extension modules, the controlling environment can easily take away all dangerous operations or replace them with protected versions.

The crucial point is that the restricted environment may call specific functions that are defined in the controlling environment, but otherwise has no access to any objects in the controlling environment. Since the controlling environment declares which functions the restricted environment can call, those functions can be written to carefully check the validity of their arguments before they perform the requested operation. For example, the controlling environment may provide a function to open a file which accepts only files in the current directory.

Using these capabilities of Python, the prototype system provides several safeguards to prevent the KOS from being damaged by a KP. As seen in FIG. 10, the KP process is divided between a supervisor 242, which runs trusted code 244 provided by the KOS 216, and the KP user code (thread) 214, which is untrusted. The user code runs in a restricted execution environment, which mediates access to unsafe operations. The restricted environment is effected by the supervisor 242, which performs all restricted operations 246, like remote procedure calls (RPCs), on behalf of the user code. The restricted environment is indistinguishable to the untrusted code running within it, with the exception that certain potentially unsafe operations are inaccessible.

There are many potential unsafe operations—for example, creating network connections, modifying files on the local disk, or communicating with other KPs executing at the same node. The trusted code removes some operations altogether and creates wrappers around other operations that enforce security policies. For example, the supervisor may provide an open operation that allows read and write operations only in particular directories. The open operation available to user code would call into the supervisor, where safety checks could be made before making the actual system call.

The KOS security model also guarantees type-safe access to distributed objects by disabling access to an object's instance variables and by performing runtime type-checking on all method calls. The trusted code creates a bastion object 248 that only allows calls to specific instance methods.

A widely deployed mobile agent system will use even stronger security measures than those mentioned above. For example, The KOS should be able to identify the owner of a KP and verify its integrity, based on a digital signature or encryption. When an agent is created it is signed or encrypted by its owner and submitted to a server; when an agent moves between two servers, the originating server encrypts the agent.

KOS Supervisor

The KOS supervisor 242 is trusted code that runs in unrestricted mode. It completely controls which objects are available to the restricted user code, either as “built-in” objects or as imported modules. Generally the supervisor can replace a dangerous but useful function with a function of its own that checks its arguments thoroughly and then calls the “real” version of the function. This replacement function is then called from restricted mode but runs in unrestricted mode. The restricted code can do nothing with such a function except call it (and pass it around). In particular it cannot use any “back doors” to exploit the unrestricted environment.

Bastion Objects

As seen in FIG. 11, to pass an object 310 into restricted mode whose methods run in unrestricted mode, it is not enough to simply pass an object created in unrestricted mode, since the restricted code will have full access to this object's attributes. Instead, a bastion object must be created and passed from unrestricted mode into the restricted environment. The bastion object 314 is hand crafted by the unrestricted environment such that it presents an identical functional API to the underlying unrestricted object. The difference is that the bastion has been instrumented so that its method attributes 315 are references 316 to (a subset of) the bound methods of the real object.

In a client/server environment, bastions are used to provide client access to remote objects. The trusted object contains instance variables and methods that allow it to make remote procedure calls to the distributed object layer. It is undesirable to export this functionality into the restricted environment, so the KP supervisor instead creates a bastion representing only the externally exported API of the remote object. The bastion itself is handcrafted in unrestricted mode, and is devoid of any other instance variables or methods. In particular, it cannot access any of the remote procedure call substrate.

A similar mechanism is used on the server side, but the direction of method binding is changed. This is because calls will be initiated from the unrestricted shell into the restricted shell in response to external RPCs. The restricted shell object contains the actual problem domain's implementation of the API, and should be implemented without regard to the actual RPC mechanism being employed underneath. The unrestricted shell contains the server side object, called the true object, which is the recipient of the RPC. To facilitate this arrangement, the bastion object is replaced with the implementation object, and bound methods from the implementation object are instrumented into the true object. Thus the object passed to self in the method's parameter list is the implementation object, with no hooks available back to the true object and the unrestricted environment.

Migration of KPs

A KP can move between distributed KOSs (located, for example, in different Internet nodes) using two primitives: migrate, which moves the current program; and clone, which creates a copy of the current program at a new location.

As seen in FIG. 8, to migrate, the KOS creates a container 250 that can be implemented in MIME format and includes the KP's source code 252, an encoded version of the current state of the program 254, a “suitcase” 256 containing application-specific data 258, and metadata 260 that describes how it should be handled by the receiving KOS. A KP calls migrate using the name of the destination KOS; the supervisor 242 interrupts the KP, captures its current state 254 in persistent form, and sends it to the specified KOS where execution resumes. (The clone operation is the same as migrate, except that the clone call returns and execution continues at the original KOS.)

The metadata 260 includes the KP's origin 262, the name of the module that contains the KP entry point 264, and instructions for handling exceptions and errors 266. To support migration, the KOS must be able to stop a running KP, serialize its state, and restart the KP at another node based on that state. In one Python implementation, a KP always resumes execution at a single entry point—its main method. A more robust system would include support for true stack mobility, which would allow a migrating KP to resume execution at any point in the program, preserving its current call stack.

The KP's state 254 includes all data stored within the KP object instance 268 and references to other objects existing within the restricted KP environment 270, including connectors (see discussion below). Objects in the supervisor are not considered part of this state.

Others have described a solution using a chain of references that point from the node where an object resided to the node it migrated to. The suitcase 256 carries data independently of the encoded program state. The suitcase holds application-created data that is not stored as an instance variable of the KP object, e.g., a log of KOSs visited or the results of a remote search. For convenience, the suitcase may act as a hierarchical file system.

The suitcase offers two significant advantages to applications: Files in the suitcase can be accessed without running the KP. Thus, an application that uses a KP to perform a remote operation can retrieve the results without incurring the overhead of starting a Python interpreter and the KP. The suitcase gives better performance to applications that create custom data representations. For example, a KP that indexes Web pages might write its index in binary form directly to the suit-case and later transfer the index directly to a search service.

Shipping Program State

A program's state roughly consists of three components: the program text (either source code or some form of (virtual) machine code), the program's data, and its execution stack. Shipping source code in text form is easy, but requires parsing on the receiving end. Python has a “compiled” form for code modules which encodes the virtual machine code in a portable way (independent of byte order and word size) which can easily be shipped. Only those modules of a program that are unique to that program need to be shipped. Other modules (e.g. those that are part of the standard Python library or implement standard Knowbot services) will already be available on the receiving host.

Migrating References to Kernel Objects

Python has a generic interface for converting a collection of Python objects into a stream of bytes (“pickling”—the reverse operation is called “unpickling”). If there were a single “root” object from which all Python objects are reachable, simply pickling the root (and thus implicitly picking everything that's reachable from the root) would create a stream of bytes that, when “unpickled”, would reincarnate the program's state. There is indeed such a root—the Python interpreter maintains a-table containing the data of all modules that were ever imported. There are two problems left, however: as with simple-minding memory dumps, kernel objects pose a problem; and we need to save and reconstruct the interpreter stack separately.

Python's standard pickle interface does not handle objects that reference kernel objects such as open files, windows or network connections. However, it allows classes to override how they are pickled and unpickled. The key is to provide Knowbot Programs with sufficiently high level abstractions for I/O so that the objects representing these abstractions can provide pickling and unpickling methods that don't require passing references to kernel objects along.

As a general guideline, the higher an object's abstraction level, the easier it will be to migrate it.

An example of how to encode the state of a KP is using a MIME representation.

Migrating the Interpreter Stack

Another hurdle for transparently migrating running Python programs is the interpreter stack. This is a list of functions (and methods) that have been called but not yet returned. The stack generally contains the local variables of each call as well as the return address, and possibly other state such as register contents or exception handling state.

The Python interpreter may be modified so that it stores all state explicitly.

Knowbot Programs Structure

A KP is nominally represented as a structured collection of elementary objects, a few of which have KP-specific formats (e.g., the representation of a running program's state can necessarily be understood by a compatible interpreter). Many of these formats may be inaccessible (e.g., text or image data; even more structured information like tables or simple databases can often be represented as lines of text).

Some KP's may need to hide some of their internal data from inspection by others. An appropriate way to do this is to encrypt the data and store it as an encrypted object in the encoded representation. Standard cryptography-based authentication techniques can be used to ensure the integrity of objects.

Even though we speak of “a KP representation”, since encoded representations can be arbitrarily nested, a single representation may actually contain any number of independent (or interdependent) Knowbot Programs. In particular, since certain objects that a KP may be carrying around with it may be protected by a separate KP for intellectual property rights protection, such objects will be represented as embedded KP representations.

A Knowbot Program's metadata includes key-metadata and non-key metadata. A Knowbot Program's key-metadata must identify the programming language it is written in (e.g. Python). The non-key metadata must include its execution state (e.g. running, sleeping, or stored on disk). A Knowbot Program's digital object data contains a number of subcomponents, including: The user program code, e.g. the source code in the programming language of choice, possibly encoded in a way that only an interpreter for the language understands, such as language specific byte code; and program specific data, such as the saved program state from a previous execution, likely accessible only via the language interpreter; and non-program specific data, such as text or images that the Program may provide upon request, possibly accessible via a repository access protocol (RAP).

All access to the data, metadata and key-metadata of a Knowbot Program is mediated by the KOE. The KOE in turn passes most requests on to the Knowbot Program, except for requests coming from the KOE itself that are used to start the execution of a Knowbot Program. Other exceptions may include requests for some metadata that is maintained by the KOE itself, or for the immutable key-metadata.

When a Knowbot Program is stored in a plain (non-KOS) repository for digital objects (perhaps while it is in transit between KOSs), the repository is required to deny most requests to access the data, metadata and key-metadata of a Knowbot Program, except those that allow the Knowbot Program to be transported to another repository or to a KOS.

Access Control to KPs

Access control addresses two related concepts: access to a Knowbot Program's data and method call application programming interface (API), and the anonymity of the Knowbot Program itself. Knowbot Programs can specify access restrictions either by providing an explicit list of authorized entities and their access level, or by checking a password or similar credential. For those accesses to the data or metadata of a Knowbot Program that are executed directly by the KOS or repository, only the first form is available.

For this purpose, each Knowbot Program must have at least one name which will be represented by a handle. Names must be verifiable by the KOS so it is impossible to pose as someone else. Standard authentication techniques are applied when a digital object is first deposited into a repository, then repositories trust each other when they pass objects between them, so the receiver can assume that the name of a Knowbot Program has been verified adequately, either directly (by the sender) or indirectly (by whichever repository first received the object). There may be two kinds of names associated with a KP. One is an archival name that is unchanging over the life of the KP. The other is a dynamic name that applies only transiently to a given instantiation of the KP. Both handles could be used for a given Knowbot program.

A predominant type of Knowbot program is a Search and Retrieval Knowbot Program. These Knowbots have the ability to carry out complicated searches against multiple databases with changing search criteria as the search evolves, e.g. from the general to the specific. For example, a Wide Area Information Service (WAIS) type search involves first finding the proper WAIS index using a general search phrase, then searching that index for documents containing specific keywords. While currently this is a manual procedure with WAIS, there exists great potential for automating this task with a Knowbot Program.

Knowbot Program Communication Via Connectors

As seen in FIG. 9, independently-running processes, including KPs and the KOS kernel, communicate with each other using connectors. Connectors are layered on top of ILU objects, adding mechanisms for creating objects and sharing references to them. Connectors preserve the integrity of the restricted execution environment, which could be compromised by offering lower-level access to object RPC mechanisms 288. A client KP 276 uses connectors to request a service, by specifying a connector name 278 and a connector type 280. The KP supervisor 242 then creates a client-side surrogate object (connector) 284 that communicates with the process 286 offering the service.

Programs offering services publish 290 their services using a connection broker 292, which binds connectors 294 to instances of class objects 296. The services class instance is bound to the symbolic connector name 298, and a connector interface type 300 registered with the KOS.

Knowbot programs define their own class objects and interface types using an interface definition language. KPs communicate with each other using connectors to these well-defined interfaces. For example, a KP whose mission is to search a remote database would migrate to the KOS managing the database and request a connector for the database's search interface.

A KP can look up a particular connector by name or request a group of connectors that provide a given type of interface. The use of connectors and ILU offers language independence for the Knowbot runtime environment. Any language that can support migration, has an ILU binding, and a safe way to restrict access to unsafe operations can be used to write Knowbot Programs.

There are several other basic properties of connectors. Connectors can be delivered by other objects. Clients can carry connectors from one Knowbot Service station with them as they travel to others, and maintain contact with the services they represent. This connector architecture enables creation of add on directory, or “trader”, services that track connectors based on more specific properties. A directory service could be implemented by a KP that exports a directory interface to clients.

Connector Broker

The connector broker 292 and a related connector manager 299 let a KP register one or more interfaces as a server, and let it interact with one or more interfaces as a client. The connector broker is part of the KP supervisor. It interfaces with the connector manager 299, which runs in the KOS kernel. There is one connector manager instance per kernel. A single KP may register one or more interfaces, of the same or different types. To register an interface, a KP calls its connector broker's register method 310 with an instance (the implementation for the interface), the identity of the interface and its type, and a list of label strings (names).

The label strings must not be already registered for the same interface type at the same KOS. The same instance may not be registered twice. To withdraw an interface, the connector broker's Unregister method 312 is called with the instance as its argument. When a KP process exits, all its remaining registered interfaces are automatically unregistered.

A KP may search the set of registered interfaces at its KOS by calling its connector broker's Lookup method 314 for a list of interfaces that have a particular type and/or those whose label strings match one or more query strings. The return value is a list of surrogate objects of the given type.

KP Execution

The following gives several examples of Knowbot programs executing or communicating in a KOE.

Non-Migrating KP

A simple example of KP communication is of a Knowbot Program that is submitted by a user to a particular KOS to execute a database search at that location. The Knowbot Program is submitted directly to the KOS, runs there for a while, and the results of its execution are then returned to its user. The search results are stored as non-program specific data in Knowbot Program (in its instantiation as a digital object) so they can be retrieved without the help of the Knowbot Program. There is only one KOS involved here, and the Knowbot Program does not have to migrate: its only state transitions are from “created” (immediately after submission) via “running” (when executing the search) to “completed” (when done). This is more or less equivalent to remote job execution in traditional systems.

Single Traveling Knowbot Program

A somewhat more complex scenario involves a single Knowbot Program that visits several KOSs to execute a database search involving multiple databases at different locations. The work-flow of KOSs to be visited is programmed into the Knowbot Program or could be dynamically determined, and the list of KOSs already visited is encoded in its program specific data. As in the previous example, the search results are stored as non-program specific data, and can be retrieved after the Knowbot Program has completed its task.

A Knowbot Program can rely on the fact that it can store the results of the search in itself. The KOS will automatically store the program state when the Knowbot program migrates to another KOS, where its state is restored automatically.

Multiple Cooperating Knowbot Programs

Some problems are easily decomposed into several parts that can be executed independently, e.g., searching multiple databases and combining the results. The searches can be executed in parallel, especially if they run on different hosts anyway. A separate program can combine the results.

For example, if we want to search three different databases and perform a join on the results, we would submit three Knowbot Programs to KOSs that are co-located with the databases of interest. These three Programs are designed to return to a home KSS once they have completed their task.

At the home KSS, a fourth Knowbot Program is run. This Program extracts the query results and combines them into the end result, displaying this information to the user. To introduce cooperation into this example, let us further assume that partial results from one search process may be used to cut another search process short; e.g., in an alpha-beta game tree pruning application, or for instance when we are searching for the lowest price of a particular item.

In our simple example, each Knowbot Program can simply periodically connect to each of the two others and transmit a summary of its search results. In order to connect, the Knowbot Programs need to know each other's handles, which can be stored in each Program when it is started, as non-program specific data.

Knowbot Program Spawning Other Knowbot Programs

In many situations, a collection of cooperating Knowbot Programs has a more dynamic character than that of the previous example. For instance, the set of databases to be searched may only be known at run time, or a compute-intensive job (like proving that a large number is a prime number, or factoring it) can be distributed over any number of available hosts for increased speed. A Knowbot Program is able to spawn other Knowbot Programs. There are actually two different possible operations: spawning a “clone” of the current Knowbot Program, including some of its current program state; spawning a “fresh” copy of a stored Knowbot Program.

The KOS where a Knowbot Program is spawned may be the same one as the host KOS of the spawning Knowbot Program, or it may be a different one. Spawning a clone to a different KOS is actually the first half of the migration operation. The second half is quitting the current Knowbot Program once it has established that the cloning operation is successful. It is presumed that the spawning and spawned Knowbot Program will know each other's handle.

A KOS and KP may need to communicate about available resources. For certain applications (like the factoring example) it may make sense for a Knowbot Program to ask a KOS explicitly what its current load is, so the Knowbot Program can decide whether to spawn another Program or not. Conversely, the KOS may notice that a particular Knowbot Program (or group of Knowbot Programs) is using up too many resources and ask it to reduce its resource usage.

A staged protocol should be used, whereby the KOS first asks a Knowbot Program politely to give up some resources, then requests it with authority. Finally, if the Knowbot Program does not seem to cooperate, the Program is terminated unconditionally.

Rendezvous Between Unrelated Knowbot Programs

So far we have considered only communication between Knowbot Programs that were submitted by the same user as part of the same task (group). Unrelated KPs also can communicate via the KOS.

Consider a used-goods market implemented using Knowbot Technology. This take the form of classified ads as they currently appear in newspapers combined with actual sales commitments. A KOS could facilitate such a market by providing match-making facilities between (prospective) buyers and sellers.

A seller submits a Knowbot Program that tells the KOS what it has for sale. The KOS adds this information to its index of sellers. A buyer submits a Knowbot Program that tells the KOS what it is looking for. The KOS gives the buyer a list of handles for Knowbot Programs that match this description. The buyer's Knowbot Program can then interact with each or some of those seller's Knowbot Programs in order to find out more about the items on sale and to possibly negotiate a sale.

Variations on this theme include: a third type of Knowbot Program, the broker, which takes the place of the KOS; buyers register passively so that sellers could be brought in contact with buyers as they are first submitted; buyers and sellers register remotely (without executing at the market site) by using remote communications; and so on.

Communicating with Other-Language Knowbot Programs

Different programming languages used to write Knowbot Programs will not all be supported by all KOSs. Even when the KOS supports a programming language, a Knowbot Program may need an unsupported language extension for execution. Knowbot Programs should be labeled (e.g. by specific key-metadata) so that a KOS can determine whether it supports all required features upon submission.

While the KOS should probably refuse unsupported Knowbot Programs submitted for execution, it can still accept them as passive digital objects. A few operations are allowed for unsupported Knowbot Programs. They can be shipped to other KOSs. Other Knowbot Programs may be allowed to retrieve key-metadata and non-program specific data from them or even modify their non-program specific data, subject to access restrictions.

Using a suitable set of conventions, marketplaces like the one sketched above could allow unsupported Knowbot Programs to participate, at least to the extent of advertising their goods wanted or for sale; a broker Knowbot Program could actively search for unsupported Knowbot Programs. Once it found a match, it could migrate one or both parties to another site where their execution is supported.

### KP EXAMPLE

An example of a complete Knowbot Program written in Python is shown in FIG. 13. This KP searches up to 20 random KOSs looking for services that implement the so-called Search.Boolean interface, storing a list of those services in its suitcase. The code shows a class definition for the KP that has four instance methods. The main method, invoked when the KP arrives at a new KOS, receives a bastion KOS object as its second argument. The bastion object provides access to KOS services like connector lookup and migration. Other applications of Knowbot technology include applications that make more efficient use of network bandwidth by moving computation closer to data or that implement widely distributed systems on top of loosely coupled, autonomous Knowbot Programs. One example of the network bandwidth conserving Knowbot Program is one that performs a search in an image database. Instead of loading each image over the network and applying some computation to it, the KP moves to the database, performs the search there, and returns with the results.

OTHER EXAMPLES

The searching example can be extended to a more general indexing Knowbot Program, where a KP moves to a database to build an index of its contents. The KOS allows multiple search services to each build their own customized index of a database without copying the database's entire contents. Intellectual property rights management and control of caching and replication are areas where the ability to create autonomous Knowbot Programs is valuable. A Knowbot Program can act as a courier for data for which access is restricted. The KP carries an encrypted version of the data and requires some authentication or payment to decrypt it or pass it to a trusted application, perhaps interacting with another KP that carries a key for decryption. A proxy server that runs Knowbot Programs provides for caching and replication of objects. A content provider interacts with a proxy server by sending a group of objects managed by a KP. The manager program could enforce access controls, perform specialized logging (hit counts), or generate dynamic pages using a database copied from the content provider. The manager also helps deal with the cache consistency program, because the manager can contain site-specific code for make decisions about freshness.

Namespace Management

One issue for mobile KPs is that of naming. The KP may be providing service at a particular KSS for 24 hours, then at a completely different KSS for the next 24 hours. Naming must apply to a KP regardless of its current location. We first distinguish the different levels of namespaces. One category of name is one that names a Knowbot Program when it's born and remains throughout its life. There is also a namespace within a KOS that provides interfaces into aspects of KPs. This namespace may traverse the KOS kernel into KP namespace. Another namespace is used for registering data types so that client and server KPs can exchange information consistently.

Knowbot Program Handles (Names)

Every Knowbot Program has at least one name, represented by handles in the KOS specification. A Knowbot Program may contain other handles: the handle of its “owner”; the handle of the particular program; the handle of this particular execution of the program. Only the last of these is unique—the other handles may be shared by several Knowbot Programs. The handle for a particular execution may or may not change when a Knowbot Program migrates to a different KOE. When a Knowbot Program spawns a copy of itself, the KOS chooses a new execution handle for it. A digital object is required to have a program handle if it has never been executed, or an execution handle if it has.

It may be convenient to have a fourth type of handle, shared by all Knowbot Programs that are related to each other via spawning or migration.

For the KOE, handles (described in the “Handles” applications) will be used as a registry for Knowbot Programs. As KPs move from KSS to KSS, the handle or name of the KP will remain the same for its life. What the name resolves to will change as the KP moves from location to location. What the name resolves to will be location dependent attributes of KPs (such as interfaces it has registered) accessed though a namespace in the KSS.

The Type Namespace

A namespace is provided that uniquely identifies types (characters, strings of characters, integers, classes, connectors, etc.) so that unrelated client and server Knowbot Programs can be sure to exchange the correct information. For example if one KP registers an interface which has a method called get_price and it returns a type price, a client KP wishing to invoke that method will need to know what a price is in order to retrieve and store the bits properly. The type namespace is thus a central clearinghouse of all types that will be exchanged and used on a particular KSS. The type namespace has three levels at its root: standard types, draft-standard-types, and non-standard types. The standard area is for those types that are exchanged between the KOS standard interfaces. For example, all of the connector manager types would be in this area. The standard area also houses the KOS extension types. Types exchanged between extensions to the KOS to access local (or remote) databases would be in this category. Before a type can become a part of the standard type namespace, it must first reside in the draft area for a period of testing and refining. The last namespace is the non-standard namespace which is an area of the namespace where types can be inserted and deleted on-the-fly. The types themselves live in subdirectories that are themselves part of the handle namespace. For example, in order for price type and a totally different price type not to collide, we place these types in subdirectories that correspond to the name of the KP that is registering them. The name of a KP is its handle.

KP Written in Python

As seen in FIG. 12, a KP written in Python must have a top-level object 340. This is the object that will be used to form the root of the pickle tree, the serialized and transportable state of the KP. This is also the object that, upon unpickling at the receiving KOS, is used to resume execution.

Other objects may exist in a KP, but they are controlled by the top-level KP object. The top-level KP object has a main entry point function with the following signature: _main_(self, kos), where self is the standard first argument to an instance method, and kos is the KOS bastion object, passed in by the KOS infrastructure. In one implementation, when a KP arrives at a new KOS, and is unpickled, the KOS resumes execution by calling this main function. This function uses the kos object to interact with the KOS infrastructure.

The kos object passed into the top-level KP object's _main_ method is used to access all the functionality of the underlying KOS infrastructure.

The KOS API is the set of interface definitions that are used as hooks into the Knowbot Programming Language to interface with the Knowbot Operating System and its extensions. The KOS API provides, for example, the low level facilities for Knowbot Program mobility. There are also facilities to allow Knowbot Programs to return themselves to the remote sender upon completion. An implementation has the ability to clone or fork Knowbot Programs in order to execute similar code in a variety of places with all the results being returned to the place of cloning.

Querying the KOS

The KOS provides a mechanism for a Knowbot Program to query the set of Knowbot Programs that it is currently managing. The query mechanism supports qualified selection on the basis of the values from the key-metadata and metadata. The resultant set of matching Knowbot Programs will only include those for which the caller has the appropriate access rights. The query returns a set of handles for the matching Knowbot Programs.

The KOS can also be queried for other properties that may be necessary for the proper operation of Knowbot Programs, such as the approximate amount of available resources (e.g. memory or CPU cycles), or the availability of certain extensions. The KOS may censor the information returned depending on the access rights of the caller.

The KOS provides a means by which Knowbot Programs can phone home and ask for confirmation upon reaching critical states in its execution. The server KOS will receive a request from a running Knowbot program to display a question on the client KSS that launched it. The server KOS will contact the client KOS requesting the service. The client KSS will display a question window on the client KSS's display awaiting a reply. Once that reply has been obtained, the client KSS forwards the answer to the server KSS which in turn forwards the reply to the running Knowbot Program. In this scenario, it's possible that the server KSS has moved the running Knowbot Program to a “waiting” state while waiting for a reply. This being the case, the server KSS will schedule and “awake” the Knowbot program and it's execution will begin where it left off.

KOS Extensions

Besides the set of standard Knowbot Program and digital object services that every KOS provides to Knowbot Programs, a KOS may export additional services, such as searching local databases, or other access to resources that are co-located with the KOS. These extensions must be made available to Knowbot Programs. A Knowbot Program may ask the host KOS whether it supports a particular extension, by name (e.g. extension handles).

Once a Knowbot Program has verified that the KOS supports a particular extension, it can bind its API for that extension to the KOS's implementation of it. The same mechanism can be used to communicate between different Knowbot Programs—even though the actual implementation of the communication is mediated by the KOS, Knowbot Programs can entertain the notion of communicating directly with each other. That is, the KOS is transparent as long as it doesn't detect security violations, resource abuse or violations of other rules it is policing.

Trigger Language

The trigger protocol implements the trigger language which tells the KOS what conditions should trigger KP interactions. Regardless of what language is used for writing the KP, to participate in scheduling based on events, it must implement part or all of the KOS trigger protocol (KTP).

The KTP is a simple declarative language that is easily parsable and compiled into fast efficient conditional code blocks. For example, assume a KP having a batch procedure that increments a variable counter corresponding to modified pages in a World Wide Web site document hierarchy. The KP stays at a KOS corresponding to the Web site, periodically, efficiently, scanning for new hits in a conditional statement represented by a trigger. The KTP may also cause a program to be run to determine when KP or KOS interactions should occur.

There are four scheduling paradigms: periodically, delayed, immediate, and via a conditional trigger mechanism. The conditional trigger is the most complex and should enable Knowbot Programs to implement powerful information discovery tools.

Triggers allow Knowbot Programs to register “conditions” with a KOS. Upon being satisfied, the Knowbot program is awakened.

The KOS trigger language is a simple declarative language intended for specifying scheduling constraints and the like for Knowbot Programs. It can bemused, for instance, to have a KP run at a specific date and time; repeatedly, e.g., hourly, nightly on weekdays, on the last Friday of the month; whenever some condition in the system becomes true, e.g. when another KP of a certain type arrives, when the load in the system reaches a certain threshold, or when another KP raises a particular flag.

The implementation of the syntax of the trigger language may be Python-like or Lisp-like. Trigger language programs consist of any number of trigger statements. The ordering of trigger statements is immaterial to their meaning. A trigger statement consists of three parts: Condition, Tolerance, Action.

Condition is a Boolean expression in a simple language supporting variables, numbers, strings, arithmetic, comparisons and Booleans.

Tolerance is an expression in the same language, indicating the urgency of the action as a time interval in seconds. If the condition swiftly oscillates within the time period of the tolerance, the action may be performed only once. This is a hint only: its meaning is as a help to avoiding frequent redundant triggers, not as an exact specification.

Action is a specification for a (possibly remote) method call to be made when the condition becomes true.

A table may be created in the KOS containing all trigger expressions. Each entry in the table may have additional fields: the value of the expression when it last triggered (if ever), a flag telling whether it is set to trigger already, and the time at which the action should be performed (based on the tolerance). When the time has come, the expression is re-evaluated and the current value stored, the flag cleared, and the time cleared; then the action is performed (all this in an atomic fashion).

Actions have the form object.method (arguments). Object specifies the object receiving the method call. Typically, this is a handle. The keyword “self” can be used to specify the KP associated with the current trigger program. Method specifies the name of the method to be called.

Trusted Applications

Any application that relates to the KOE must be qualified as part of the trusted environment maintained by the KOE. Qualified KPs are registered with the KOE. For some applications, not all of the application will need to be registered, only portions which must be trusted. User interfaces, for example, may not need to be registered.

User Interface

Form-based and other user interfaces will be employed by end-users to construct and customize Knowbot Programs. Other user interface components will report status information on roaming Knowbot Programs launched by the user. Still other interfaces will be used by administrators to manage and monitor resource allocation on Knowbot Operating Systems under her control. In all such cases, a graphical user interface framework is used to support user interfaces within the Knowbot Operating Environment. Grail is one example of a browser framework for communication with many different types of Internet information sources. At present, it is HTML 2.0 compliant, can interact with Repository based systems, and provides an extensible and open architecture for platform independent graphical user interfaces. Grail is implemented in Python.

As Knowbot Programs are launched out into the world to perform their tasks, they will periodically report back with status information, or the results of their tasks. Inevitably, such reporting will have interactions with the user, perhaps to clarify search parameters, to request approval for additional funds, or simply to let the user know that it is still alive and working on the task. Grail can serve as the focus of all user interface activity for the personal KSS.

It is conceivable that a number of standard search and retrieval Knowbot Programs will exist, and other common Knowbot Program subcomponents will be available for the user to draw upon when constructing his or her Knowbot Programs. A Grail extension could be written which would provide a forms-based dialog for construction and customizing of these standard Knowbot Program components—a kind of visual programming environment popular on various other platforms. Developers will also need standard program development, testing, and debugging tools as they build more complex Knowbot Programs or components. Grail can serve the developer in this capacity as well, interfacing to underlying language tools and editors. In the case of Python Knowbot Programs, Grail may even contain native debugging and testing extensions allowing the developer to write and test such programs directly. For non-Python Knowbot Programs, Grail extensions can be written that will interface with those foreign language tools.

Grail extensions can also provide the tools KSS administrators will need in order to monitor and manage the Knowbot Programs currently living within their environment. Grail may even provide a way for KSS administrators to directly connect to Knowbot Programs within the KSS, allowing the administrator to force some Knowbot Programs to sleep, or kicking them off their systems, for example.

Other embodiments are within the scope of the following, claims.

What is claimed is:

1. (canceled)

2. A method for providing service facilities to a mobile program in a distributed system having nodes, comprising
in an operating environment in each of the nodes, providing service facilities useful to the mobile program, and
in the service facilities running a supervisor process that allows the mobile program indirect access to make use of the node's operating environment, the supervisor process creating a bastion object in an unrestricted environment to protect the unrestricted environment and running the restricted environment within which the mobile program is running.

3. The method of claim 2 in which the bastion object provides an interface for the mobile program to access the service facilities in a safe manner and which is substantially the same interface as the interface that the service facilities provide in the unrestricted environment.

4. The method of claim 2 in which the bastion object performs type checking on all method calls made by a mobile program to a service facility.

5. A method for use in a distributed system for processing a mobile program that executes in one node of the distributed system, may be interrupted at almost any point in its execution, and may be moved to another node of the distributed system for further execution, comprising
in the one node, capturing a current state of the mobile program execution, delivering the captured state and program code of the mobile program to the other node, and
continuing execution at the other node from the point of interruption based on the captured state and the program code.

6. The method of claim 5 further comprising
also delivering with the captured state and the program code a transported file system or other information created during execution of the mobile program.

7. The method of claim 6 in which the information in the transported file system or other information is accessible without executing the mobile program.

8. The method of claim 5 in which the step of capturing comprises using an encoding scheme of a language interpreter.

9. A method for enabling communication with a mobile program running in a distributed system, a mobile program service station, an extension, or another application, comprising
providing a mechanism which enables each of mobile program and the mobile program service station the extension, or the other application to identify services that it provides, and enables each of them to find services that it needs.

10. The method of claim 9 in which each of the objects is provided by a supervisor process running in the distributed environment and prevents uncontrolled access to a needed service.

11. The method of claim 9 in which the mechanism includes a broker and manager.

12. The method of claim 9 in which the objects are data typed.

13. A method for enabling negotiation between two unrelated mobile programs, mobile program service stations, extensions, or other applications, in a distributed system, comprising
in an operating environment in a node of the distributed system, receiving information from one of the two mobile programs, mobile program service stations, extensions, or other applications, concerning a transaction offered to other mobile programs, mobile program service stations, extensions, or other applications,
in the operating environment in the node, receiving information from the second of the two mobile programs, mobile program service stations, extensions, or other applications concerning a transaction in which the second of the mobile programs, mobile program service stations, extensions, and other applications wishes to engage,
notifying the other second mobile program, mobile program service station, extension, or other application of the one mobile program, mobile program service station, extension, or other application, and
enabling the two mobile programs, mobile program services stations, extensions, or other applications to communicate concerning the transaction.

14. The method of claim 13 in which the information is received from the two mobile programs by a third mobile program.

15. A method for enabling action by an operating environment in a distributed system with respect a mobile program which is programmed in a language that is not fully supported by the operating environment, comprising
labeling a mobile program to identify operating environment features required for full support of the mobile program,
in an operating environment, examining the labeling of the mobile program to determine whether the operating environment supports identified features, and taking an action based on whether all the identified features are supported.

16. The method of claim 15 wherein the action comprises sending the mobile program to another operating environment for processing.

17. The method of claim 15 in which the action comprises retrieving non-program specific data from the mobile program.

18. A method for aiding communication with a mobile program executing in a distributed system, comprising
maintaining a name space of identifiers that uniquely identify one of more types of information that may be communicated, and
in connection with a communication.

19. The method of claim 18 in which the mobile program registers or otherwise records an interface which includes the identifier of the type of information that is to be communicated

20. (canceled)

21. (canceled)

22. (canceled)

23. (canceled)

24. A method for controlling interaction between a mobile program and an application running in an operating environment provided at a node of a distributed system, comprising
defining a trusted portion of the operating environment which provides trusted services to the mobile program,
requiring portions of the application running in the operating environment to be registered as trusted, and
permitting indirect interaction via the operating environment between the mobile program and the application running in the operating environment only if the portions of the application required to be registered have been registered.

25. A method for enabling a mobile program to carry out defined functions including otherwise unsafe functions, through the use of extensions comprising
coding safe extensions to an operating environment and to the interpretive language under which the mobile program runs, and permitting the mobile program to carry out the defined functions by making use of the extensions.

26. The method of claim 9 in which the mechanism comprises a connector mechanism, and the objects comprise connector objects.

27. The method of claim 2 in which the service facilities of the operating environment are used to access other resources not part of the operating environment.

28. The method of claim 2 in which the supervisor process prohibits unauthorized access to the service facilities of the operating environment.

29. The method of claim 18 in which the name space allocates unique identifiers to one or more types of information.

30. The method of claim 9 also including
enabling the mobile program to communicate with mobile program service stations via objects associated with the mechanism.
